(19) United States
(12) Patent Application Publication
(10) Pub. No.: US 2010/0219981 A1
(43) Pub. Date: Sep. 2, 2010

(54) Antenna including first and second radiating elements having substantially the same characteristic features

(75) Inventor: Alireza Hormoz Mohammadian, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/063,017

(22) PCT Filed: Oct. 4, 2007
(86) PCT No.: PCT/US2007/080490

§ 371 Date: Feb. 5, 2008

Related U.S. Application Data
(60) Provisional application No. 60/896,772, filed on Mar. 23, 2007.

(51) Int. Cl. H01Q 9/04; H01Q 1/24; H04R 3/00; G08C 19/00

(52) U.S. Cl. 340/870.01; 343/702; 343/700 MS; 381/384

(57) ABSTRACT

An apparatus including an antenna for wireless communications is disclosed. The antenna includes a first radiating element and a second radiating element electromagnetically coupled to and electrically isolated from the first radiating element. The first radiating element includes at least one characteristic feature that is substantially the same as at least one characteristic feature of the second radiating element. The first radiating element may be configured as a planar monopole having various shapes, such as elliptical, circular, triangular, square, rectangular, diamond, or polygon. The planar monopole may further be electrically coupled to a flat or curved metallic load. The first radiating element may also be configured as a cone. The second radiating element may be configured as a flat or curved metal structure.

### CLAIM OF PRIORITY UNDER 35 U.S.C. §119

The present Application for Patent is a national stage submission under 35 U.S.C. §371 of Patent Application No. PCT/US2007/080829 entitled “Antenna including first and second radiating elements having substantially the same characteristic features” filed Oct. 9, 2007, pending, which claims priority to Provisional Application No. 60/896,772 entitled “Ultra-Wide Band Antennas,” filed Mar. 23, 2007, pending, and assigned to the assignee hereof and hereby expressly incorporated by reference herein.

### BACKGROUND

1. Field

The present disclosure relates generally to communications systems, and more specifically, to an antenna comprising first and second radiating elements having substantially the same characteristic features.

2. Background

Communications devices that operate on a limited power supply, such as a battery, typically use techniques to provide the intended functionality while consuming relatively small amounts of power. One technique that has been gaining in popularity relates to transmitting signals using pulse modulation techniques. This technique generally involves transmitting information using low duty cycle pulses and operating in a low power mode during times when not transmitting the pulses. Thus, in these devices, the efficiency is typically better than communications devices that operate a transmitter continuously.

Since, in some applications, the pulses may have a relatively small duty cycle, the antenna used for transmitting or receiving the pulses should minimize the effects it has on the shape or frequency content of the pulses. Thus, the antenna should have a relatively large bandwidth. Further, since the antenna may be used in low power applications where a limited power supply, such as a battery, is used, the antenna should have relatively high efficiency in transmitting or receiving signals to and from a wireless medium. Thus, its return loss across the intended bandwidth should be relatively high. Additionally, since the antenna may be used in applications where it needs to be incorporated in a relatively small housing, the antenna should also have a relatively compact configuration.

### SUMMARY

An aspect of the disclosure relates to an apparatus for wireless communications. The apparatus comprises a first radiating element and a second radiating element electromagnetically coupled to and electrically isolated from the first radiating element. The first radiating element includes at least one characteristic feature that is substantially the same as at least one characteristic feature of the second radiating element.

In another aspect, the first radiating element includes at least one characteristic feature that extends substantially perpendicular to at least one characteristic feature of the second radiating element. In yet another aspect, the first radiating element includes at least one characteristic feature that extends substantially parallel to at least one characteristic feature of the second radiating element. In still another aspect, the first radiating element includes at least one characteristic feature that extends from at least one characteristic feature of the second radiating element at a defined acute angle. In also another aspect, a characteristic feature of the first or second radiating element may comprise a direction, width, height, area or volume.

In another aspect, the first radiating element comprises a cone and the second radiating element comprises a substantially flat plate, wherein the at least one characteristic feature of the cone comprises an area of its opening and the at least one characteristic feature of the substantially flat plate comprises its surface area.

In another aspect, the first radiating element comprises an electrically conductive plate. The electrically conductive plate may be configured to include any of the following shapes: elliptical, circular, triangular, square, rectangular, diamond, or polygon. In yet another aspect, a metallic load may be provided that is electrically coupled to the electrically conductive plate. The metallic load may be configured as a substantially flat plate or to have a shape that substantially follows at least a portion of the contour of the electrically conductive plate.

In another aspect, the first radiating element comprises a cone that, in turn, comprises a metal, or a metal and a dielectric, such as a plastic, Mylar, Telflon, polyimide, FR4, duriod, PTFE, etc. In yet another aspect, the first radiating element comprises a substantially hollow cone and a cap that substantially encloses the hollow cone. The hollow cone may comprise an inner surface including an electrical insulator and an outer surface including a metal.

In another aspect, the apparatus may further comprise a feed that is electrically coupled to the first radiating element and electrically insulated from the second radiating element. In another aspect, the first radiating element may comprise a substantially hollow cone, wherein at least a portion of the feed is situated within the hollow cone. Additionally, in another aspect, the apparatus may further comprise a circuit adapted to transmit or receive a signal via the feed, and a battery adapted to supply electrical power to the circuit, wherein at least a portion of the circuit and at least a portion of the battery are disposed within the hollow cone. Further, in another aspect, at least a portion of the battery forms a cap to substantially enclose the hollow cone.

In another aspect, the apparatus may comprise a third radiating element that is electrically coupled to the feed, wherein the third radiating element is electromagnetically coupled to and electrically insulated from the second radiating element. In another aspect, the feed forms part of or is electrically coupled to a center conductor of a coaxial transmission line. In another aspect, the feed is electrically coupled to a printed circuit board, which may be configured as a microstrip or stripline.

In another aspect, the second radiating element comprises an electrically conductive plate. The electrically conductive plate may have a defined curved surface. In yet another aspect, the first and second radiating elements are adapted to transmit or receive a signal within a defined ultra-wide band (UWB) channel that has a fractional bandwidth on the order of 20% or more, a bandwidth on the order of 500 MHz or more, or a fractional bandwidth on the order of 20% or more and a bandwidth on the order of 500 MHz or more.

Other aspects, advantages and novel features of the present disclosure will become apparent from the following detailed description of the disclosure when considered in conjunction with the accompanying drawings.

### BRIEF DESCRIPTION OF THE DRAWINGS

FIGS. 1A-B illustrate front and side, partial cross-sectional views of an exemplary metallic-loaded planar monopole antenna in accordance with an aspect of the disclosure.

FIGS. 2A-B illustrate front and side, partial cross-sectional views of another exemplary metallic-loaded planar monopole antenna in accordance with another aspect of the disclosure.

FIGS. 3A-B illustrate front and side, partial cross-sectional views of an exemplary angled, metallic-loaded planar monopole antenna in accordance with another aspect of the disclosure.

FIGS. 4A-B illustrate front and side, partial cross-sectional views of another exemplary angled, metallic-loaded planar monopole antenna in accordance with another aspect of the disclosure.

FIG. 5 illustrates a front, partial cross-sectional view of an exemplary metallic-loaded planar monopole antenna coupled to a coaxial transmission line in accordance with another aspect of the disclosure.

FIG. 6 illustrates a front, partial cross-sectional view of an exemplary metallic-loaded planar monopole antenna coupled to a printed circuit board in accordance with another aspect of the disclosure.

FIG. 7 illustrates a front, partial cross-sectional view of another exemplary metallic-loaded planar monopole antenna coupled to a printed circuit board in accordance with another aspect of the disclosure.

FIG. 8 illustrates a front, partial cross-sectional view of an exemplary cone antenna in accordance with another aspect of the disclosure.

FIG. 9 illustrates a front, partial cross-sectional view of an exemplary angled, cone antenna in accordance with another aspect of the disclosure.

FIG. 10 illustrates a front, partial cross-sectional view of an exemplary cone antenna with a cap in accordance with another aspect of the disclosure.

FIG. 11 illustrates a front, partial cross-sectional view of another exemplary metallic-coated, cone-shaped antenna in accordance with another aspect of the disclosure.

FIG. 12 illustrates a front, partial cross-sectional view of an exemplary dual cone antenna in accordance with another aspect of the disclosure.

FIG. 13 illustrates a front, partial cross-sectional view of an exemplary cone antenna coupled to a coaxial transmission line in accordance with another aspect of the disclosure.

FIG. 14 illustrates a front, partial cross-sectional view of an exemplary cone antenna coupled to a printed circuit board in accordance with another aspect of the disclosure.

FIG. 15 illustrates a front, partial cross-sectional view of another exemplary cone antenna coupled to a printed circuit board in accordance with another aspect of the disclosure.

FIG. 16 illustrates a front, partial cross-sectional view of another exemplary cone antenna with a curved second radiating element in accordance with another aspect of the disclosure.

FIG. 17 illustrates a front, partial cross-sectional view of an exemplary substantially-hollow cone antenna including a feed situated within the hollow in accordance with another aspect of the disclosure.

FIG. 18 illustrates a front, partial cross-sectional view of another exemplary substantially-hollow cone antenna including a feed, circuit, and battery situated within the hollow cone in accordance with another aspect of the disclosure.

FIG. 19 illustrates a block diagram of an exemplary communications device in accordance with another aspect of the disclosure.

FIG. 20 illustrates a block diagram of another exemplary communications device in accordance with another aspect of the invention.

FIG. 21 illustrates a block diagram of another exemplary communications device in accordance with another aspect of the invention.

FIGS. 22A-D illustrate timing diagrams of various pulse modulation techniques in accordance with another aspect of the disclosure.

FIG. 23 illustrates a block diagram of various communications devices communicating with each other via various channels in accordance with another aspect of the disclosure.

### DETAILED DESCRIPTION

Various aspects of the disclosure are described below. It should be apparent that the teachings herein may be embodied in a wide variety of forms and that any specific structure, function, or both being disclosed herein are merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

As an example of some of the above concepts, in some aspects, the apparatus may comprise a first radiating element and a second radiating element electromagnetically coupled to and electrically isolated from the first radiating element. The first radiating element includes at least one characteristic feature that is substantially the same as at least one characteristic feature of the second radiating element. As discussed in more detail below, the first radiating element may be configured as a planar monopole having various shapes, such as elliptical, circular, triangular, square, rectangular, diamond, or polygon. The planar monopole may further be electrically coupled to a flat or curved metallic load. The first radiating element may also be configured as a cone. The second radiating element may be configured as a flat or curved metal structure.

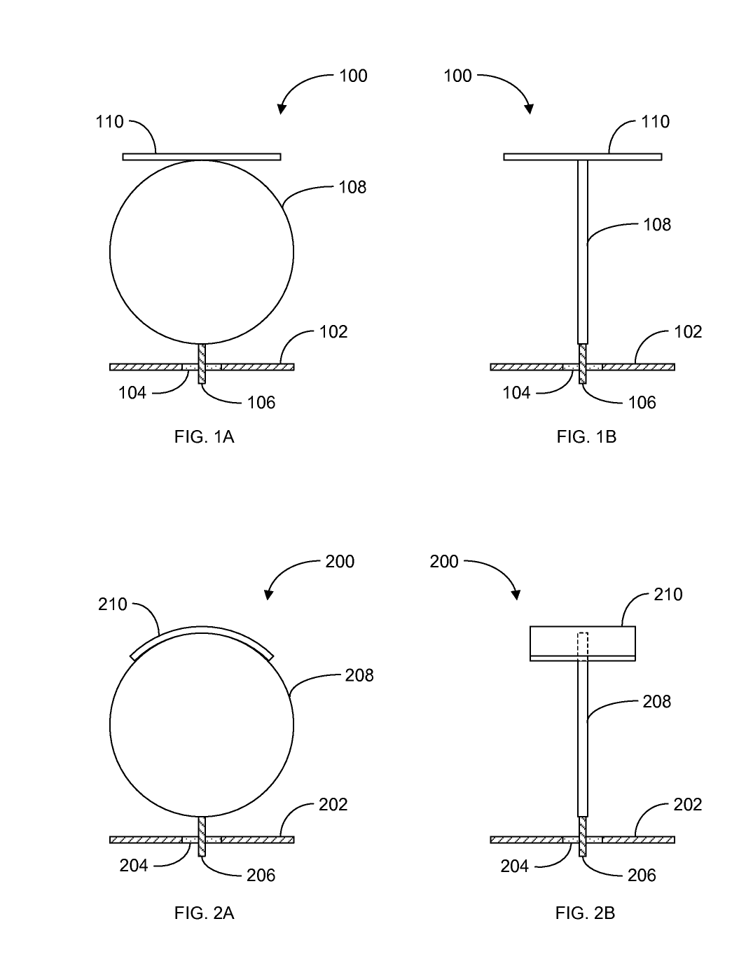

FIGS. 1A-B illustrate front and side, partial cross-sectional views of an exemplary metallic-loaded planar monopole antenna 100 in accordance with an aspect of the disclosure. The antenna 100 comprises a first radiating element 108 and a second radiating element 102 that is electromagnetically coupled to the first radiating element 108, as well as electrically insulated from the first radiating element 108. The antenna 100 further comprises a metallic load 110 which is electrically coupled to the first radiating element 108 near a top portion thereof. Additionally, the antenna 100 further comprises a feed 106 that is electrically coupled to the first radiating element 108, as well as electrically insulated from the second radiating element 102. An insulating material 104 may be used to electrically insulate or separate the feed 106 from the second radiating element 102, and also provide structural support for the feed 106.

In this example, the first radiating element 108 is configured as a substantially planar and circular metal structure. The first radiating element 108 may be configured as a solid metal structure or may be configured as a dielectric which has a metallization layer disposed thereon. Although, in this example, the first radiating element 108 has a circular shape, it shall be understood that it may have other shapes, such as elliptical, triangular, square, rectangular, diamond, or polygon. Also, in this example, the metallic load 110 is configured as a substantially planar structure that is positioned to make contact to the top portion of the first radiating element 108. The metallic load 110 may be configured as a solid metal structure or may be configured as a dielectric which has a metallization layer disposed thereon.

The second radiating element 102 may also be configured as a substantially planar and circular metal plate. However, it shall be understood that the second radiating element 102 may have different shapes. The second radiating element 102 may be electrically coupled to ground potential. In this example, the second radiating element 102 includes the electrical insulator 104 to electrically isolate it from the feed 106. The feed 106 may extend from below the second radiating element 102 as shown, through a centralized opening within the electrical insulator 104, and to the first radiating element to make electrical contact thereto. The feed 106 routes signals to the first radiating element 108 for radiating into a wireless medium. The feed 106 routes signals picked up by the first radiating element 108 to other components for processing.

In the antenna 100, the first radiating element 108 includes at least one characteristic feature that is substantially the same as at least one characteristic feature of the second radiating element 102. A characteristic feature of a radiating element includes a spatial parameter that dictates a primary effect on the frequency response of the antenna 100, such as its low frequency roll off, bandwidth, or high frequency roll off. For example, for the case where the first and second radiating elements 108 and 102 are circular, the characteristic feature may include the radius, diameter, or area of the circle. Thus, in this example, the radius, diameter or area of the circular first radiating element 108 may be configured substantially the same as the radius, diameter, or area of the second radiating element 102, respectively.

As another example, the first radiating element 108 may be configured as having a substantially planar elliptical shape. In such a case, the length of the minor axis of the ellipse substantially dictates the low frequency roll off of the antenna. Thus, if the second radiating element 102 is configured as a circular plate, then the minor axis of the elliptical first radiating element 108 may be configured to have substantially the same length as the diameter of the circular second radiating element 102. Generally, the longest dimension of a shape typically dictates the low frequency roll off of an antenna, although this may not be the case for the elliptical radiating element.

The orientation of the characteristic feature of the first radiating element 108 may be configured substantially parallel to the characteristic feature of the second radiating element 102. For instance, taking the above example where the first radiating element 108 has a substantially planar elliptical shape and the second radiating element 102 has substantially a planar circular shape, the elliptical first radiating element 108 may be configured to have its minor axis oriented substantially parallel to the surface of the circular second radiating element 102. In this orientation, the major axis of the elliptical first radiating element 108 is substantially perpendicular to the surface of the circular second radiating element 102.

The orientation of the characteristic feature of the first radiating element 108 may also be configured substantially perpendicular to the characteristic feature of the second radiating element. For instance, taking again the above example where the first radiating element 108 has a substantially planar elliptical shape and the second radiating element 102 has substantially a planar circular shape, the elliptical first radiating element 108 may be configured to have its minor axis oriented substantially perpendicular to the surface of the circular second radiating element 102. In this orientation, the major axis of the elliptical first radiating element 108 is substantially parallel to the surface of the circular second radiating element 102.

In some sample aspects associated with an elliptical first radiating element 108 and a circular second radiating element 102, the height or major axis of the ellipse may be approximately between 8-20 millimeters (mm), such as 11.4 mm; the width or minor axis of the ellipse may also be approximately between 8-20, such as 10.0 mm; and the diameter of the circle may be approximately between 5-20 mm, such as 10.0 mm. With these parameters, this antenna may operate suitably within the UWB defined in this disclosure such as between 6-10 GHz. and preferably between 7-9 GHz.

FIGS. 2A-B illustrate front and side, partial cross-sectional views of another exemplary metallic-loaded planar monopole antenna 200 in accordance with another aspect of the disclosure. In summary, the antenna 200 is similar to antenna 100, except that it has a curved metallic load that substantially follows the contour of the upper portion of the first radiating element. In particular, the antenna 200 comprises a first radiating element 208, a second radiating element 202, a feed 206, an electrical insulator 204, and a metallic load 210. The first and second radiating elements 208 and 202, feed 206, and electrical insulator 204 may be configured substantially the same as the first and second radiating elements 108 and 102, feed 106, and electrical insulator 104 of antenna 100 as previously discussed.

However, in this example, the metallic load 210 is curved in a manner that substantially follows the top portion of the first radiating element 208. In the example shown where the first radiating element 208 is configured as having a substantially planar circular shape, the metallic load 210 is curved in substantially a circular manner having a radius substantially the same as the radius of the first radiating element 208. It shall be understood that if the first radiating element 208 has a different shape, such as an ellipse, the metallic load 210 may be configured to have a shape that substantially follows the contour of a portion of the ellipse. As in the previous antenna, the metallic load 210 may be configured as a solid metal or a dielectric having a metallization disposed thereon.

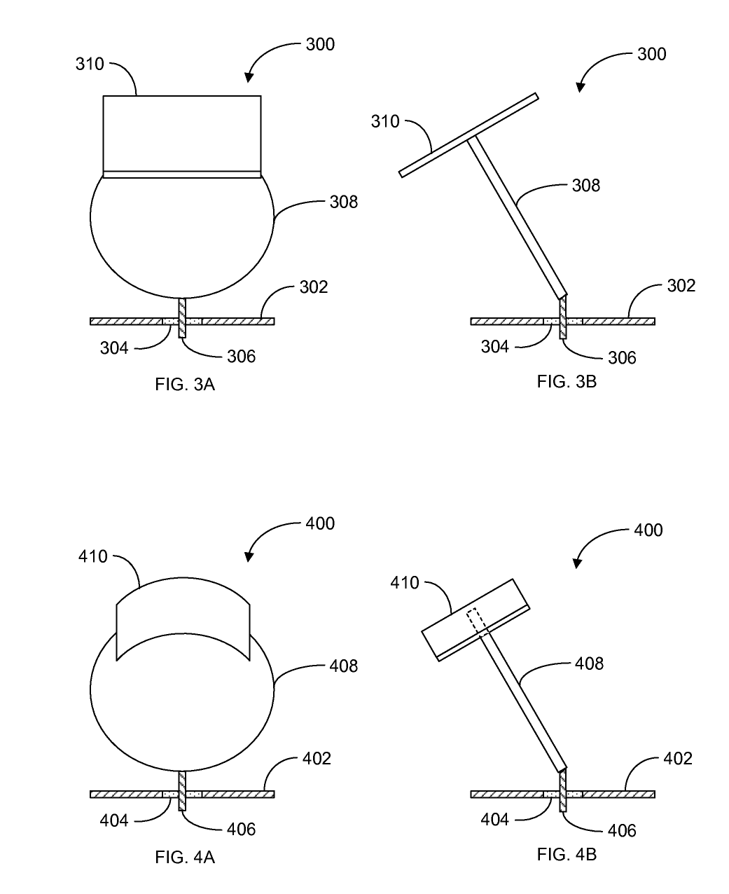

FIGS. 3A-B illustrate front and side, partial cross-sectional views of an exemplary angled, metallic-loaded planar monopole antenna 300 in accordance with another aspect of the disclosure. In summary, the antenna 300 is similar to antenna 100, except that the first radiating element is angled with respect to the second radiating element. In particular, the antenna 300 comprises a first radiating element 308, a second radiating element 302, a feed 306, an electrical insulator 304, and a metallic load 310. The second radiating element 302, feed 306, electrical insulator 304, and metallic load 310 may be configured substantially the same as the second radiating element 102, feed 106, electrical insulator 104, and metallic load 110 of antenna 100 as previously discussed.

However, in this example, the first radiating element 308 extends from the second radiating element 302 at a defined acute angle. This orientation may result in the characteristic feature of the first radiating element 308 to extend from the characteristic feature of the second radiating element 302 at the defined acute angle. For example, if the first radiating element 308 is configured as having a planar elliptical shape, the elliptical first radiating element 308 may be configured so that its minor axis extends from the bottom of the first radiating element 308 towards the metallic load 310. If the second radiating element 302 is configured as having a planar circular shape and has a characteristic feature, such as its diameter, that extends substantially parallel to its surface, then the characteristic feature (the minor axis) of the elliptical first radiating element 308 would extend from the characteristic feature (diameter) of the circular second radiating element 302 at the defined acute angle.

FIGS. 4A-B illustrate front and side, partial cross-sectional views of another exemplary angled, metallic-loaded planar monopole antenna 400 in accordance with another aspect of the disclosure. In summary, the antenna 400 is similar to antenna 200, except that the first radiating element is angled with respect to the second radiating element. In particular, the antenna 400 comprises a first radiating element 408, a second radiating element 402, a feed 406, an electrical insulator 404, and a metallic load 410. The second radiating element 402, feed 406, electrical insulator 404, and metallic load 410 may be configured substantially the same as the second radiating element 202, feed 206, electrical insulator 204, and metallic load 210 of antenna 200 as previously discussed.

However, in this example, the first radiating element 408 extends from the second radiating element 402 at a defined acute angle. As previously discussed with reference to antenna 300, this orientation may result in the characteristic feature of the first radiating element 408 to extend from the characteristic feature of the second radiating element 402 at the defined acute angle.

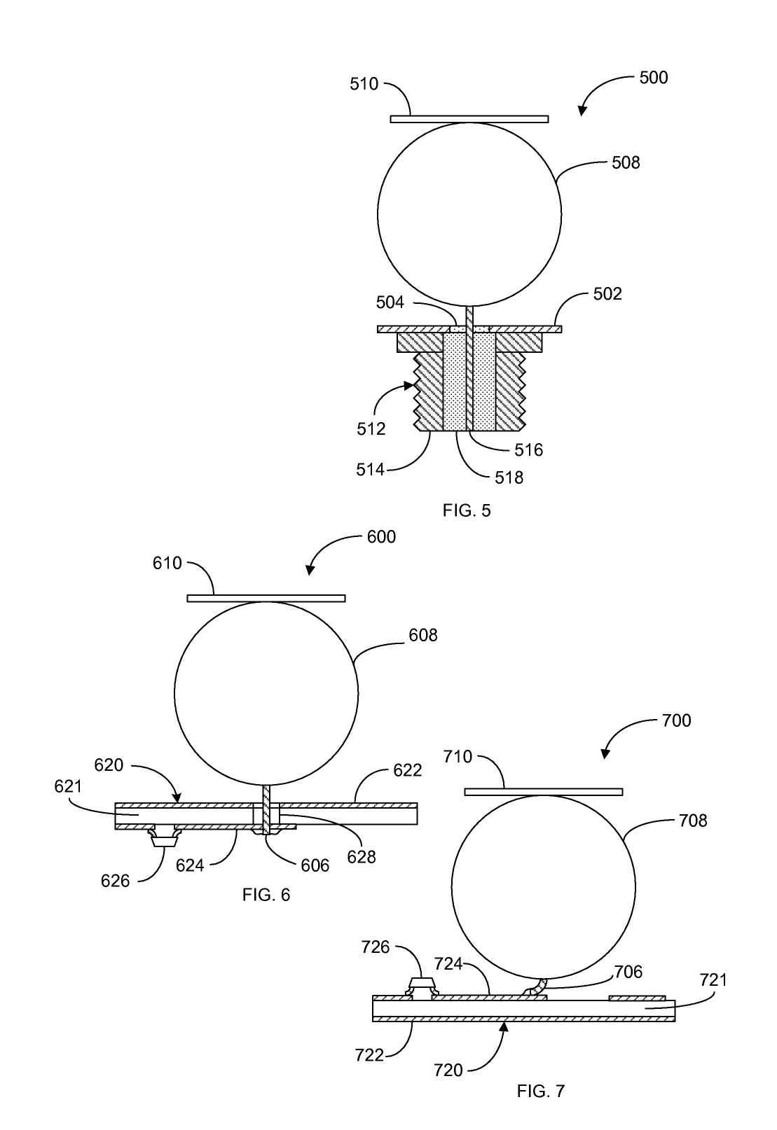

FIG. 5 illustrates a front, partial cross-sectional view of an exemplary metallic-loaded planar monopole antenna 500 coupled to a coaxial transmission line in accordance with another aspect of the disclosure. In summary, the antenna 500 is similar to antenna 100, except that the feed is electrically coupled or part of the central conductor of a coaxial transmission line. In particular, the antenna 500 comprises a first radiating element 508, a second radiating element 502, an electrical insulator 504, and a metallic load 510. The first and second radiating elements 508 and 502, electrical insulator 504, and metallic load 510 may be configured substantially the same as the first and second radiating elements 108 and 102, electrical insulator 104, and metallic load 110 of antenna 100 as previously discussed.

However, in this example, the antenna 500 further includes a coaxial transmission line 512 for routing a signal to or from the first radiating element 508. The coaxial transmission line 512, in turn, comprises an outer electrical conductor 514, a central electrical conductor 516, and a dielectric or electrical insulator 518 disposed between the outer and central conductors 514 and 516. As is customary for coaxial transmission lines, the central conductor 516 may be configured as a substantially circular rod, the dielectric 518 may be configured substantially as a ring surrounding and in contact with the central conductor 516, and the outer conductor 514 may also be configured substantially as a ring surrounding and in contact with the ring-shaped insulator 518. The outer conductor 514 may further include threads for matting with other components that interface with the antenna 500.

As previously mentioned, the central conductor 516 of the coaxial transmission line 516 is electrically coupled to the first radiating element 508. As such, the coaxial transmission line 512 is able to route a signal to the first radiating element 508 for radiation into a wireless medium, and is able to route a signal from the first radiating element 508 to another component. Although in this example, the antenna 500 is configured as the antenna 100 except for the coaxial transmission line 512, it shall be understood that the coaxial transmission line 512 may be configured to interface with any of the antennas described herein.

FIG. 6 illustrates a front, partial cross-sectional view of an exemplary metallic-loaded planar monopole antenna 600 coupled to a printed circuit board in accordance with another aspect of the disclosure. In summary, the antenna 600 is similar to antenna 100, except that the feed is electrically coupled to a signal metallization trace of a printed circuit board. In particular, the antenna 600 comprises a first radiating element 608, a feed 606, and a metallic load 610. The first radiating element 608, feed 606, and metallic load 610 may be configured substantially the same as the first radiating element 108, feed 106, and metallic load 110 of antenna 100 as previously discussed.

However, in this example, the antenna 600 further includes a printed circuit board 620 for routing a signal to or from the first radiating element 608. The printed circuit board 620 may be configured as a microstrip. In particular, the printed circuit board 620 comprises a dielectric substrate 621, a ground metallization plane 622 disposed on an upper side of the substrate 621, and a signal metallization trace 624 disposed on a lower side of the substrate 621. The printed circuit board 620 may further include one or more components, such as component 626, for processing the signal sent to and/or received from the first radiating element 608. In this example, the feed 606 is electrically coupled to the signal metallization trace 624. The feed 606 extends from the signal metallization trace to the first radiating element 608 through a non-plated via hole 628. The feed 606 is electrically insulated from the ground metallization plane 622. In this case, the ground metallization plane 622 operates as the second radiating element which is electromagnetically coupled to and electrically insulated from the first radiating element 608. It shall be understood that the printed circuit board 620 may be used to send and/or receive signals from the first radiating element of any antennas described herein.

FIG. 7 illustrates a front, partial cross-sectional view of another exemplary metallic-loaded planar monopole antenna 700 coupled to a printed circuit board in accordance with another aspect of the disclosure. In summary, the antenna 700 is similar to antenna 600, except that the printed circuit board is flipped up-side-down. In particular, the antenna 700 comprises a first radiating element 708, a feed 706, and a metallic load 710. The first radiating element 708 and metallic load 710 may be configured substantially the same as the first radiating element 608 and metallic load 610 of antenna 600 as previously discussed.

However, in this example, the antenna 700 further includes a printed circuit board 720 that includes the signal metallization trace on its upper side and the ground metallization plane on its lower side. In particular, the printed circuit board 720 comprises a dielectric substrate 721, a ground metallization plane 722 disposed on a lower side of the substrate 721, and a signal metallization trace 724 disposed on an upper side of the substrate 721. The printed circuit board 720 may further include one or more components, such as component 726, for processing the signal sent to and/or received from the first radiating element 708. In this example, the feed 706 is electrically coupled to the signal metallization trace 724. In this case, the ground metallization plane 722 operates as the second radiating element which is electromagnetically coupled to and electrically insulated from the first radiating element 708. It shall be understood that the printed circuit board 720 may be used to send and/or receive signals from the first radiating element of any antennas described herein.

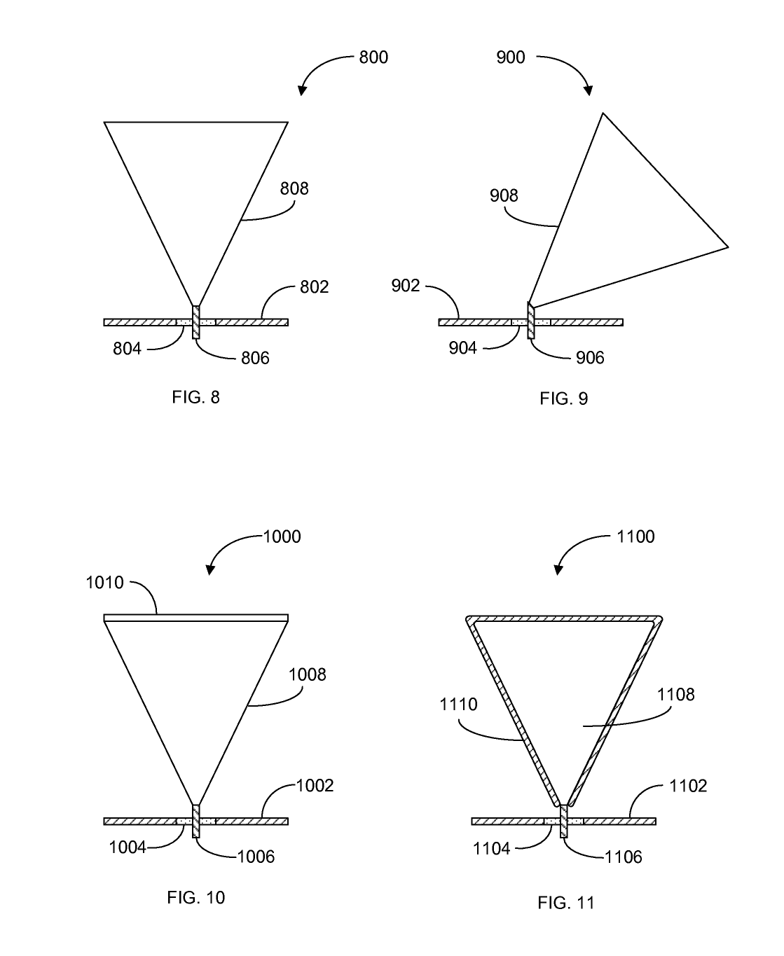

FIG. 8 illustrates a front, partial cross-sectional view of an exemplary cone antenna 800 in accordance with another aspect of the disclosure. The antenna 800 is similar to the antennas previously discussed, except that the first radiating element is configured as a cone instead of an electrically conductive plane. In particular, the antenna 800 comprises a first radiating element 808 having a conical shape, and a second radiating element 802 electromagnetically coupled to and electrically insulated from the first radiating element 808. The cone may be substantially solid, partially hollow, or substantially hollow. The antenna 800 may further comprise a feed 806 that is electrically coupled to the first radiating element 808 and electrically insulated from the second radiating element 802. The antenna 800 may further include an electrical insulator 804 to electrically insulate the feed 806 from the second radiating element 802 and provide structural support for the feed 806.

In this example, the cone-shaped first radiating element 808 is oriented such that the apex of the cone is situated proximate the bottom of the cone, and the central axis of the cone extends substantially vertical and perpendicular to the second radiating element 802. Also, in this example, the feed 806 electrically connects to the cone-shaped first radiating element 808 at proximate its apex region. As discussed with regard to the previous antennas, the feed 806 may extend snugly through a centralized opening in the electrical insulator 804, which is surrounded by and attached to the second radiating element 802. The second radiating element 802, electrical insulator 804, and feed 806 may be configured substantially the same as those previously discussed with regard to the antennas 100 through 400.

As with the previously discussed antennas, the first radiating element 808 includes at least one characteristic feature that is substantially the same as a characteristic feature of the second radiating element 802. For example, a characteristic feature of the cone-shaped first radiating element 808 is the area of its opening or top surface of the cone. In the case the second radiating element 802 is configured as substantially a circular metallization plate, a characteristic feature of the second radiating element 802 may be the surface area of the plate. Accordingly, the cone-shaped first radiating element 808 includes a characteristic feature (area of its opening or top surface) that is substantially the same as the surface area of the circular plate second radiating element 802.

In this example, the characteristic feature (area of its opening or its top surface) of the cone-shaped first radiating element 808 is substantially parallel to the characteristic feature (surface area) of the circular plane second radiating element 802 (e.g., they are parallel planes). If, for example, the characteristic feature of the cone-shaped first radiating element 808 is its height (i.e., the distance from the apex to its opening or top surface along the central axis), the characteristic feature (height) of the first radiating element 808 may extend substantially perpendicular to the characteristic feature (surface) of the circular plane second radiating element 802.

In some sample aspects, the height of the cone may be configured to be approximately 10 mm to 15 mm, the diameter of the opening or top surface of the cone may be configured to be approximately 10 mm to 15 mm, and the diameter or width of the second radiating element 802 may be configured to be approximately 10 mm to 15 mm. With these parameters, this antenna may operate suitably within the UWB defined in this disclosure such as between 6-10 GHz. and preferably between 7-9 GHz.

FIG. 9 illustrates a front, partial cross-sectional view of an exemplary angled, cone antenna 900 in accordance with another aspect of the disclosure. In summary, the antenna 900 is similar to antenna 800, except that the first radiating element is angled with respect to the second radiating element. In particular, the antenna 900 comprises a cone-shaped first radiating element 908, a second radiating element 902, a feed 906, and an electrical insulator 904. The second radiating element 902, feed 906, and electrical insulator 904 may be configured substantially the same as the second radiating element 802, feed 806, and electrical insulator 804 of antenna 800 as previously discussed.

However, in this example, the first radiating element 908 extends from the second radiating element 902 at a defined acute angle. In particular, the central axis of the cone-shaped first radiating element 908 extends from the second radiating element 902 at a defined acute angle. This orientation may result in the characteristic feature of the first radiating element 908 to extend from the characteristic feature of the second radiating element 902 at the defined acute angle. For example, if the characteristic feature of the first radiating element 908 is the area of the opening or top surface of the cone, and the characteristic feature of the second radiating element 902 is the surface area of its planar structure, then the characteristic feature (cone opening or top surface) extends from the surface of the second radiating element 902 at a defined acute angle. This also applies for the case where the characteristic feature of the first radiating element is the height of the cone along its central axis.

FIG. 10 illustrates a front, partial cross-sectional view of an exemplary cone antenna with a cap in accordance with another aspect of the disclosure. In summary, the antenna 1000 is similar to antenna 800, except that it further includes a cap covering the opening of the cone. In particular, the antenna 1000 comprises a first radiating element 1008, a second radiating element 1002, a feed 1006, and an electrical insulator 1004. The second radiating element 1002, feed 1006, and electrical insulator 1004 may be configured substantially the same as the second radiating element 802, feed 806, and electrical insulator 804 of antenna 800 as previously discussed.

However, in this example, the antenna 1000 further includes a cap 1010 that entirely covers the opening of the first radiating element 1008. In this example, the first radiating element 1008 is configured as a partially hollow or substantially hollow cone. The cap 1010 may be configured as a solid metal or a dielectric having a metallization disposed on at least its exterior surface. The cap 1010 makes electrical contact to the first radiating element 1008 such that it effectively operates as part of the first radiating element 1008.

FIG. 11 illustrates a front, partial cross-sectional view of another exemplary metallic-coated, cone-shaped antenna 1100 in accordance with another aspect of the disclosure. In summary, the antenna 1100 is similar to antenna 800, except that the cone is made out of a dielectric material that has a metallization layer disposed on substantially its entire exterior surface. In particular, the antenna 1100 comprises a first radiating element 1108 including a metallization layer 1110, a second radiating element 1102, a feed 1106, and an electrical insulator 1104. The second radiating element 1102, feed 1106, and electrical insulator 1104 may be configured substantially the same as the second radiating element 802, feed 806, and electrical insulator 804 of antenna 800 as previously discussed.

However, in this example, the first radiating element comprises a dielectric material 1108 serving at the structure of a cone, and a metallization layer 1110 disposed substantially on its entire external surface. The dielectric cone 1108 may be a solid, partially hollow, or substantially hollow. The feed 1106 is electrically coupled to the metallization layer 110 near the apex of the cone.

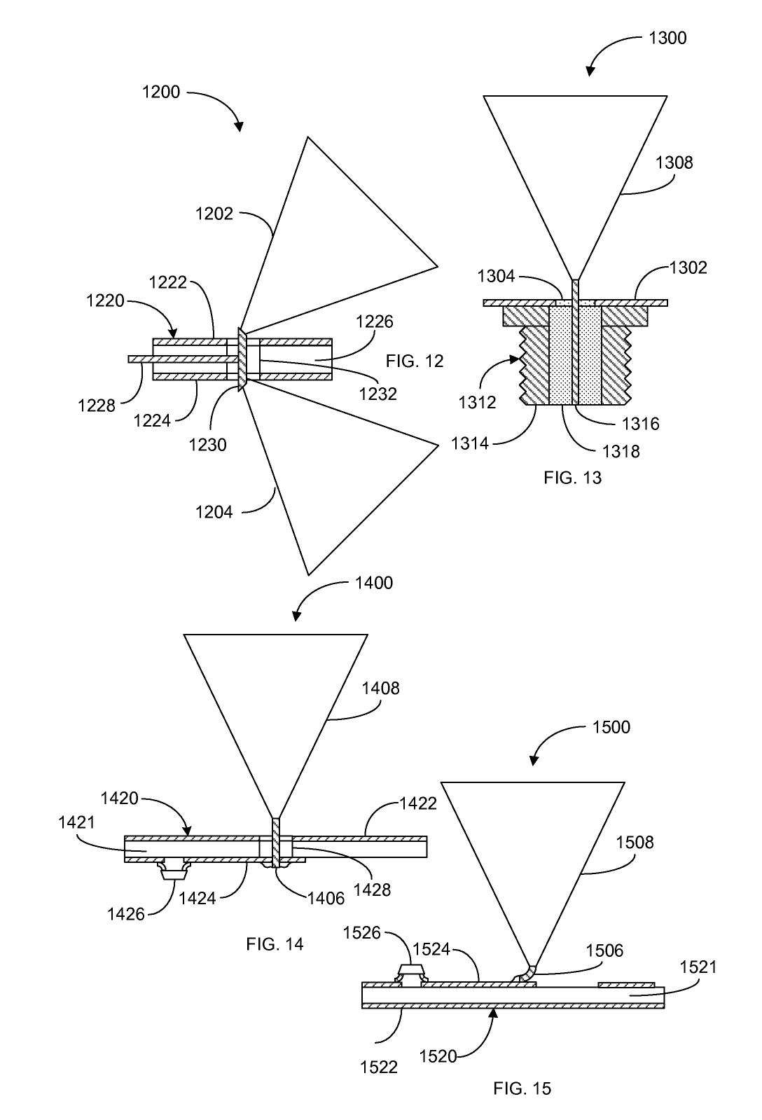

FIG. 12 illustrates a front, partial cross-sectional view of an exemplary dual cone antenna 1200 in accordance with another aspect of the disclosure. The antenna 1200 differs from prior antennas in that it includes three radiating elements. In particular, the antenna 1200 comprises a cone-shaped first radiating element 1202 and a cone-shaped second radiating element 1204 that is electrically coupled to the cone-shaped first radiating element 1202 via a feed 1230. The first and second radiating elements 1202 and 1204 may be coupled to a printed circuit board 1220, which may be configured as a stripline.

The printed circuit board 1220, in turn, comprises a dielectric substrate 1226, an upper ground metallization plane 1222 disposed on an upper side of the dielectric substrate 1226, and a lower ground metallization plane 1224 disposed on a lower side of the dielectric substrate 1226. The printed circuit board 1220 further comprises a signal metallization trace 1228 for routing a signal to or from the first and second radiating elements 1202 and 1204 via the feed 1230. The signal metallization trace 1228 is embedded within the dielectric substrate 1226. The feed 1230 may extend from below the printed circuit board 1220, where it makes electrical contact to the second radiating element 1204, to above the printed circuit board 1220, where it makes electrical contact to the first radiating element 1202, via a non-plated via hole 1232 through the dielectric substrate 1226. The feed 1230 is electrically insulated from the upper and lower ground metallization planes 1222 and 1224. In this case, the upper and lower ground metallization planes 1222 and 1224 serve as the third radiating element that is electromagnetically coupled to and electrically insulated from the first and second radiating elements 1202 and 1204.

FIG. 13 illustrates a front, partial cross-sectional view of an exemplary cone antenna 1300 coupled to a coaxial transmission line in accordance with another aspect of the disclosure. In summary, the antenna 1300 is similar to antenna 800, except that the feed is electrically coupled to or part of the central conductor of a coaxial transmission line. In particular, the antenna 1300 comprises a first radiating element 1308, a second radiating element 1302, and an electrical insulator 1304. The first and second radiating elements 1308 and 1302, and electrical insulator 1304 may be configured substantially the same as the first and second radiating elements 808 and 802, and electrical insulator 804 of antenna 800 as previously discussed.

However, in this example, the antenna 1300 further includes a coaxial transmission line 1312 for routing a signal to or from the first radiating element 1308. The coaxial transmission line 1312 may be configured substantially the same as coaxial transmission line 512 of antenna 500. In particular, the coaxial transmission line 1312 comprises a central conductor 1316 which is electrically coupled to the first radiating element 1308, an electrical insulator 1318, and an outer electrical conductor 1314. The central conductor 1316, electrical insulator 1318, and outer electrical conductor 1314 may be configured substantially the same as the central conductor 516, electrical insulator 518, and outer electrical conductor 514 of antenna 500 previously discussed.

FIG. 14 illustrates a front, partial cross-sectional view of an exemplary cone antenna 1400 coupled to a printed circuit board in accordance with another aspect of the disclosure. In summary, the antenna 1400 is similar to antenna 800, except that the feed is electrically coupled to a signal metallization trace of a printed circuit board. In particular, the antenna 1400 comprises a first radiating element 1408 and a printed circuit board 1420. The first radiating element 1408 may be configured as the first radiating element 808 of antenna 800 previously discussed. The printed circuit board 1420 may be configured substantially the same as the printed circuit board 620 of antenna 600 previously discussed, and includes a dielectric substrate 1421, a metallization ground plane 1422, a signal metallization trace 1424, one or more signal processing components 1426, and non-plated via hole 1428 as previously discussed with reference to antenna 600.

FIG. 15 illustrates a front, partial cross-sectional view of another exemplary cone antenna coupled to a printed circuit board in accordance with another aspect of the disclosure. In summary, the antenna 1500 is similar to antenna 1400, except that the printed circuit board is flipped up side down. In particular, the antenna 1500 comprises a first radiating element 1508 and a printed circuit board 1520. The first radiating element 1508 may be configured as the first radiating element 1408 of antenna 1400 previously discussed. The printed circuit board 1520 may be configured substantially the same as the printed circuit board 720 of antenna 700 previously discussed, and includes a dielectric substrate 1521, a metallization ground plane 1522, a signal metallization trace 1524, and one or more signal processing components 1526, as previously discussed with reference to antenna 700.

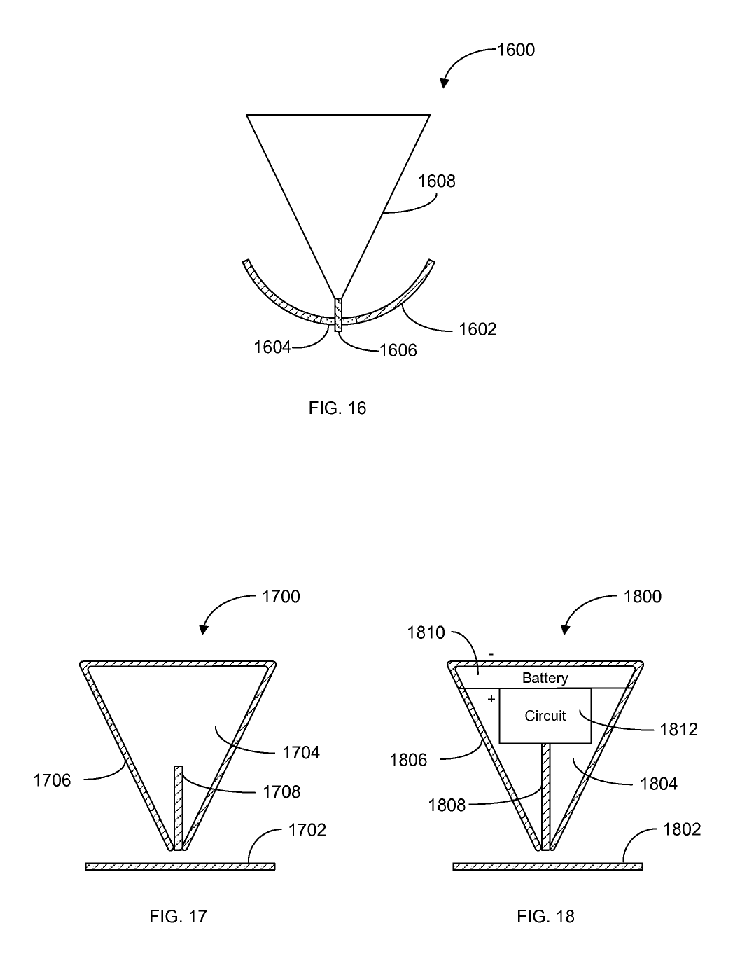

FIG. 16 illustrates a front, partial cross-sectional view of another exemplary cone antenna 1600 with a curved second radiating element in accordance with another aspect of the disclosure. In summary, the antenna 1600 is similar to antenna 800, except that the second radiating element has a defined curved shape. In particular, the antenna 1600 comprises a first radiating element 1608, a second radiating element 1602, an electrical insulator 1604, and a feed 1606. The first radiating element 1608 and feed 1606 may be configured substantially the same as the first radiating element 808 and feed 806 of antenna 800 previously discussed. In this case, the second radiating element 1602 and the electrical insulator 1604 may have a defined curved shape.

FIG. 17 illustrates a front, partial cross-sectional view of another exemplary substantially-hollow cone antenna 1700 including a feed situated within the hollow in accordance with another aspect of the disclosure. In summary, the antenna 1700 comprises a first radiating element 1704 including a dielectric cone 1704 and a metallization layer 1706 disposed substantially on its entire exterior surface, and a feed 1708 situated within the dielectric cone 1704 and making electrical contact to the metallization layer 1706 proximate the apex of the cone. The antenna 1700 further comprises a second radiating element 1702 that is electromagnetically coupled to and electrically insulated from the first radiating element (1704 and 1706). The first and second radiating elements may be oriented in any manner as previously discussed with reference to the prior cone-shaped antennas.

FIG. 18 illustrates a front, partial cross-sectional view of another exemplary substantially-hollow cone antenna including a feed, circuit, and antenna situated within the hollow cone in accordance with another aspect of the disclosure. In summary, the antenna 1800 comprises a first radiating element 1804 including a dielectric cone 1804 and a metallization layer 1806 disposed substantially on its entire exterior surface, a battery 1810 situated within the dielectric cone 1804, a circuit 1812 situated within the dielectric cone 1804, and a feed 1808 also situated within the dielectric cone 1804. In this example, the battery 1820 may be configured as a cap to cover the opening of the cone 1804. The negative terminal of the battery 1810 may be electrically coupled to the metallization layer 1806 of the dielectric cone 1804. The positive terminal of the battery 1810 may be electrically coupled to the circuit 1812 for supplying electrical power thereto. The circuit 1812 may be adapted to process signals received from or sent to the first radiating element 1806 via the feed 1808, which makes electrical contact to the metallization layer 1806 proximate the apex of the cone. The antenna 1800 further comprises a second radiating element 1802 that is electromagnetically coupled to and electrically insulated from the first radiating element 1806. The first and second radiating elements may be oriented in any manner as previously discussed with reference to the prior cone-shaped antennas.

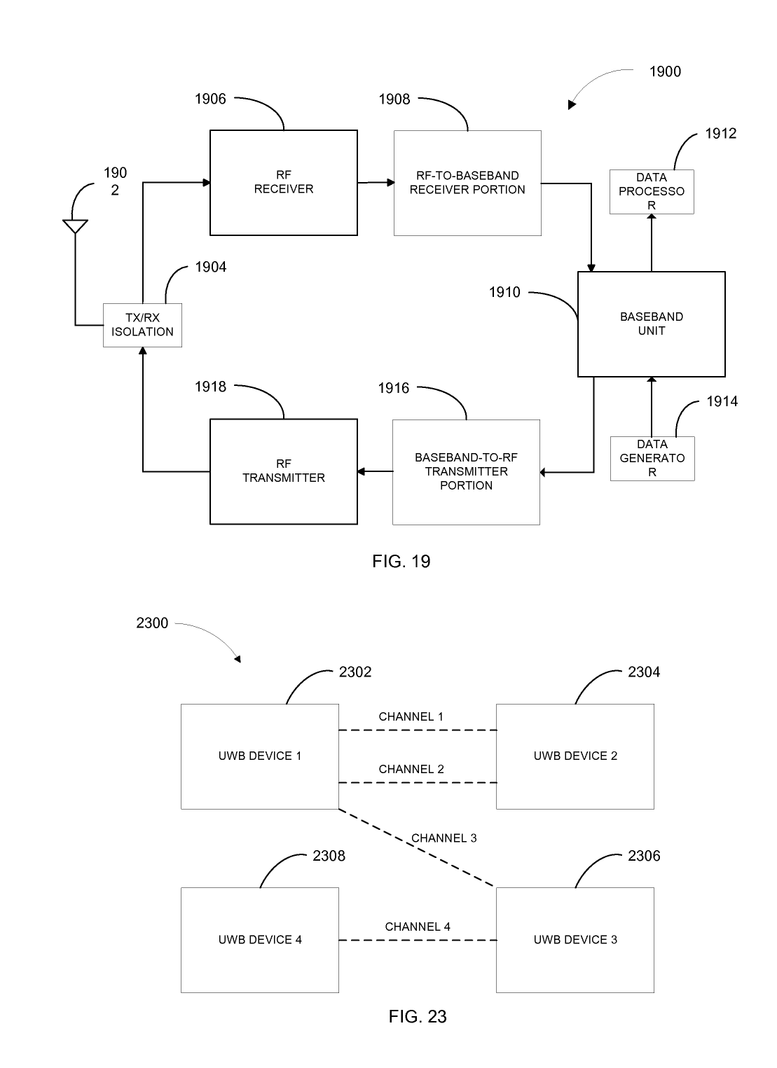

FIG. 19 illustrates a block diagram of an exemplary communications device 1900 in accordance with another aspect of the disclosure. The communications device 1900 may be particularly suited for sending and receiving data to and from other communications devices. The communications device 1900 comprises an antenna 1902, a Tx/Rx isolation device 1904, a radio frequency (RF) receiver 1906, an RF-to-baseband receiver portion 1908, a baseband unit 1910, a data processor 1912, a data generator 1914, a baseband-to-RF transmitter portion 1916, and an RF transmitter 1918. The antenna 1902 may be configured as any one of the antennas previously discussed.

In operation, the data processor 1912 may receive data from another communications device via the antenna 1902 which picks up the RF signal from the communications device, the Tx/Rx isolation device 1904 which routes the signal to the RF receiver 1906, the RF receiver 1906 which amplifies the received signal, the RF-to-baseband receiver portion 1908 which converts the RF signal into a baseband signal, and the baseband unit 1910 which processes the baseband signal to determine the received data. The data processor 1912 may then perform one or more defined operations based on the received data. For example, the data processor 1912 may include a microprocessor, a microcontroller, a reduced instruction set computer (RISC), etc.

Further, in operation, the data generator 1914 may generate outgoing data for transmission to another communications device via the baseband unit 1910 which processes the outgoing data into a baseband signal for transmission, the baseband-to-RF transmitter portion 1916 which converts the baseband signal into an RF signal, the RF transmitter 1918 which conditions the RF signal for transmission via the wireless medium, the Tx/Rx isolation device 1904 which routes the RF signal to the antenna 1902 while isolating the input of the RF receiver 1906, and the antenna 1902 which radiates the RF signal into the wireless medium. The data generator 1914 may be a sensor or other type of data generator.

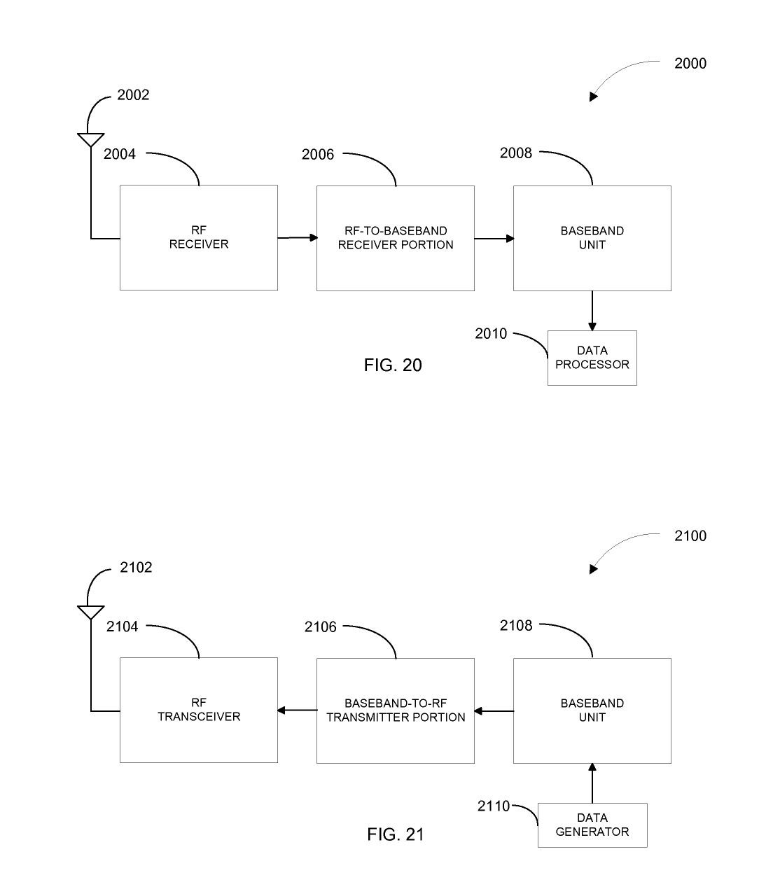

FIG. 20 illustrates a block diagram of an exemplary communications device 2000 in accordance with another aspect of the disclosure. The communications device 2000 may be particularly suited for receiving data from other communications devices. The communications device 2000 comprises an antenna 2002, an RF receiver 2004, an RF-to-baseband receiver portion 2006, a baseband unit 2008, and a data processor 2010. The antenna 2002 may be configured as any one of the antennas previously discussed.

In operation, the data processor 2012 may receive data from another communications device via the antenna 2002 which picks up the RF signal from the communications device, the RF receiver 2004 which amplifies the received signal, the RF-to-baseband receiver portion 2006 which converts the RF signal into a baseband signal, and the baseband unit 2008 which processes the baseband signal to determine the received data. The data processor 2010 may then perform one or more defined operations based on the received data. For example, the data processor 2010 may include a microprocessor, a microcontroller, a reduced instruction set computer (RISC), etc.

FIG. 21 illustrates a block diagram of an exemplary communications device 2100 in accordance with another aspect of the disclosure. The communications device 2100 may be particularly suited for sending data to other communications devices. The communications device 2100 comprises an antenna 2102, an RF transmitter 2104, a baseband-to-RF transmitter portion 2106, a baseband unit 2108, and a data generator 2110. The antenna 2102 may be configured as any one of the antennas previously discussed.

In operation, the data generator 2110 may generate outgoing data for transmission to another communications device via the baseband unit 2108 which processes the outgoing data into a baseband signal for transmission, the baseband-to-RF transmitter portion 2106 which converts the baseband signal into an RF signal, the transmitter 2104 which conditions the RF signal for transmission via the wireless medium, and the antenna 2102 which radiates the RF signal into the wireless medium. The data generator 2110 may be a sensor or other type of data generator.

In any of the above communications devices 1900, 2000, and 2100, a user interface may be employed to provide visual, audible or thermal indication associated with the received or outgoing data. As examples, a user interface may include a display, one or more light emitting diodes (LED), audio transducers such as a microphone or one or more speakers, and others. Any of the above communications devices 1900, 2000, and 2100 may be employed in any type of applications, such as in a medical device, shoe, watch, robotic or mechanical device, a headset, a global positioning system (GPS) device, and others.

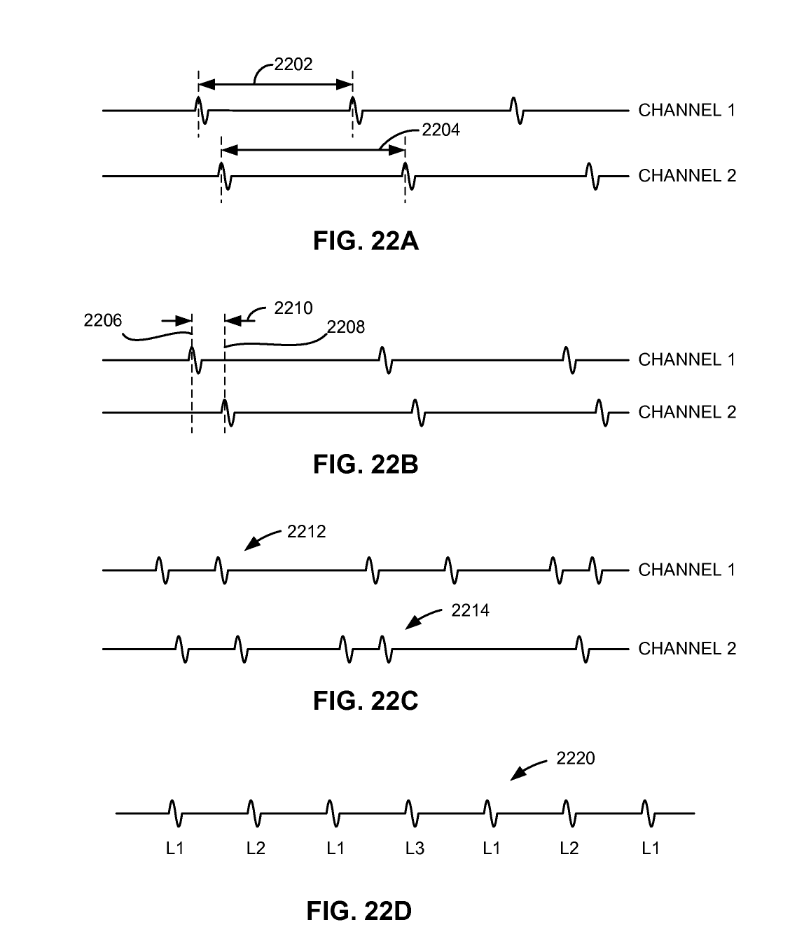

FIG. 22A illustrates different channels (channels 1 and 2) defined with different pulse repetition frequencies (PRF) as an example of a PDMA modulation. Specifically, pulses for channel 1 have a pulse repetition frequency (PRF) corresponding to a pulse-to-pulse delay period 2202. Conversely, pulses for channel 2 have a pulse repetition frequency (PRF) corresponding to a pulse-to-pulse delay period 2204. This technique may thus be used to define pseudo-orthogonal channels with a relatively low likelihood of pulse collisions between the two channels. In particular, a low likelihood of pulse collisions may be achieved through the use of a low duty cycle for the pulses. For example, through appropriate selection of the pulse repetition frequencies (PRF), substantially all pulses for a given channel may be transmitted at different times than pulses for any other channel.

The pulse repetition frequency (PRF) defined for a given channel may depend on the data rate or rates supported by that channel. For example, a channel supporting very low data rates (e.g., on the order of a few kilobits per second or Kbps) may employ a corresponding low pulse repetition frequency (PRF). Conversely, a channel supporting relatively high data rates (e.g., on the order of a several megabits per second or Mbps) may employ a correspondingly higher pulse repetition frequency (PRF).

FIG. 22B illustrates different channels (channels 1 and 2) defined with different pulse positions or offsets as an example of a PDMA modulation. Pulses for channel 1 are generated at a point in time as represented by line 2206 in accordance with a first pulse offset (e.g., with respect to a given point in time, not shown). Conversely, pulses for channel 2 are generated at a point in time as represented by line 2208 in accordance with a second pulse offset. Given the pulse offset difference between the pulses (as represented by the arrows 2210), this technique may be used to reduce the likelihood of pulse collisions between the two channels. Depending on any other signaling parameters that are defined for the channels (e.g., as discussed herein) and the precision of the timing between the devices (e.g., relative clock drift), the use of different pulse offsets may be used to provide orthogonal or pseudo-orthogonal channels.

FIG. 22C illustrates different channels (channels 1 and 2) defined with different timing hopping sequences. For example, pulses 2212 for channel 1 may be generated at times in accordance with one time hopping sequence while pulses 2214 for channel 2 may be generated at times in accordance with another time hopping sequence. Depending on the specific sequences used and the precision of the timing between the devices, this technique may be used to provide orthogonal or pseudo-orthogonal channels. For example, the time hopped pulse positions may not be periodic to reduce the possibility of repeat pulse collisions from neighboring channels.

FIG. 22D illustrates different channels defined with different time slots as an example of a PDM modulation. Pulses for channel L1 are generated at particular time instances. Similarly, pulses for channel L2 are generated at other time instances. In the same manner, pulse for channel L3 are generated at still other time instances. Generally, the time instances pertaining to the different channels do not coincide or may be orthogonal to reduce or eliminate interference between the various channels.

It should be appreciated that other techniques may be used to define channels in accordance with a pulse modulation schemes. For example, a channel may be defined based on different spreading pseudo-random number sequences, or some other suitable parameter or parameters. Moreover, a channel may be defined based on a combination of two or more parameters.

FIG. 23 illustrates a block diagram of various ultra-wide band (UWB) communications devices communicating with each other via various channels in accordance with another aspect of the disclosure. For example, UWB device 1 2302 is communicating with UWB device 2 2304 via two concurrent UWB channels 1 and 2. UWB device 2302 is communicating with UWB device 3 2306 via a single channel 3. And, UWB device 3 2306 is, in turn, communicating with UWB device 4 2308 via a single channel 4. Other configurations are possible. The communications devices may be used for many different applications, and may be implemented, for example, in a headset, microphone, biometric sensor, heart rate monitor, pedometer, EKG device, watch, shoe, remote control, switch, tire pressure monitor, or other communications devices.

Any of the above aspects of the disclosure may be implemented in many different devices. For example, in addition to medical applications as discussed above, the aspects of the disclosure may be applied to health and fitness applications. Additionally, the aspects of the disclosure may be implemented in shoes for different types of applications. There are other multitude of applications that may incorporate any aspect of the disclosure as described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. An apparatus for wireless communications, comprising:
a first radiating element; and
a second radiating element electromagnetically coupled to and electrically insulated from the first radiating element, wherein at least one characteristic feature of the first radiating element is substantially the same as at least one characteristic feature of the second radiating element.

2. The apparatus of claim 1, wherein at least one characteristic feature of the first radiating element extends substantially perpendicular to at least one characteristic feature of the second radiating element.

3. The apparatus of claim 1, wherein at least one characteristic feature of the first radiating element extends substantially parallel to at least one second characteristic feature of the second radiating element.

4. The apparatus of claim 1, wherein at least one characteristic feature of the first radiating element extends from at least one characteristic feature of the second radiating element at a defined acute angle.

5. The apparatus of claim 1, wherein at least one characteristic feature of the first or second radiating element comprises a direction, a length, a width, a height, an area, or a volume.

6. The apparatus of claim 1, wherein the first radiating element comprises a cone and the second radiating element comprises a substantially flat plate, wherein the at least one characteristic feature of the cone comprises an area of its opening and the at least one characteristic feature of the substantially flat plate includes its surface area.

7. The apparatus of claim 1, wherein the first radiating element includes an electrically conductive plate.

8. The apparatus of claim 7, wherein the electrically conductive plate has substantially any of the following shapes: elliptical, circular, triangular, square, rectangular, diamond, or polygon.

9. The apparatus of claim 7, further comprising a metallic load electrically coupled to the electrically conductive plate.

10. The apparatus of claim 9, wherein the metallic load is substantially flat or has a shape that substantially follows at least a portion of a contour of the electrically conductive plate.

11. The apparatus of claim 1, wherein the first radiating element comprises a cone that comprises a metal or a metal and a dielectric.

12. The apparatus of claim 1, wherein the first radiating element comprises a substantially hollow cone and further comprising a cap that substantially encloses the hollow cone.

13. The apparatus of claim 12, wherein the hollow cone comprises an inner surface comprising an electrical insulator, and an outer surface comprising a metal.

14. The apparatus of claim 1, further comprising a feed electrically coupled to the first radiating element, wherein the feed is electrically insulated from the second radiating element.

15. The apparatus of claim 14, wherein the first radiating element comprises a substantially hollow cone, and further wherein at least a portion of the feed is situated within the hollow cone.

16. The apparatus of claim 15, further comprising:
a circuit adapted to transmit or receive a signal via the feed; and
a battery adapted to supply electrical power to the circuit, wherein at least a portion of the circuit and at least a portion of the battery are disposed within the hollow cone.

17. The apparatus of claim 16, wherein at least a portion of the battery forms a cap to substantially enclose the hollow cone.

18. The apparatus of claim 14, further comprising a third radiating element electrically coupled to the feed, wherein the third radiating element is electromagnetically coupled to and electrically insulated from the second radiating element.

19. The apparatus of claim 14, wherein the feed forms part of or is electrically coupled to a center conductor of a coaxial transmission line.

20. The apparatus of claim 14, wherein the feed is electrically coupled to a printed circuit board.

21. The apparatus of claim 20, wherein the printed circuit board is configured as a microstrip or stripline.

22. The apparatus of claim 1, wherein the second radiating element comprises an electrically conductive plate.

23. The apparatus of claim 22, wherein the electrically conductive plate has a defined curved surface.

24. The apparatus of claim 1, wherein the first and second radiating elements are adapted to transmit or receive a signal within a defined ultra-wide band channel that has a fractional bandwidth on the order of 20% or more, has a bandwidth on the order of 500 MHz or more, or has a fractional bandwidth on the order of 20% or more and has a bandwidth on the order of 500 MHz or more.

25. A method for wireless communications, comprising:
electromagnetically coupling a first radiating element to a second radiating element;
electrically insulating the first radiating element from the second radiating element; and
configuring at least one characteristic feature of the first radiating element to be substantially the same as at least one characteristic feature of the second radiating element.

26. The method of claim 25, further comprising configuring at least one characteristic feature of the first radiating element to extend substantially perpendicular to at least one characteristic feature of the second radiating element.

27. The method of claim 25, further comprising configuring at least one characteristic feature of the first radiating element to extend substantially parallel to at least one characteristic feature of the second radiating element.

28. The method of claim 25, further comprising configuring at least one characteristic feature of the first radiating element to extend from at least one characteristic feature of the second radiating element at a defined acute angle.

29. The method of claim 25, further comprising configuring at least one characteristic feature of the first or second radiating element to comprise a direction, a length, a width, a height, an area, or a volume.

30. The method of claim 25, further comprising:
configuring the first radiating element as a cone;
configuring the second radiating element as a substantially flat plate; and
configuring the at least one characteristic feature of the cone to include an area of an opening of the cone; and
configuring the at least one characteristic feature of the substantially flat plate to include a surface area of the substantially flat plate.

31. The method of claim 25, further comprising configuring the first radiating element as an electrically conductive plate.

32. The method of claim 31, further comprising configuring the electrically conductive plate to have a shape that is substantially elliptical, circular, triangular, square, rectangular, diamond, or polygon.

33. The method of claim 31, further comprising providing a metallic load electrically coupled to the electrically conductive plate.

34. The method of claim 33, further comprising configuring the metallic load to be substantially flat or have a shape that substantially follows at least a portion of a contour of the electrically conductive plate.

35. The method of claim 25, further comprising configuring the first radiating element as a cone that comprises a metal or a metal and a dielectric.

36. The method of claim 25, further comprising:
configuring the cone to be substantially hollow; and
providing a cap that substantially encloses the hollow cone.

37. The method of claim 36, further comprising configuring the hollow cone to include an inner surface comprising an electrical insulator, and an outer surface comprising a metal.

38. The method of claim 25, further comprising:
providing a feed electrically coupled to the first radiating element; and
configuring the feed to be electrically insulated from the second radiating element.

39. The method of claim 38, further comprising:
configuring the first radiating element as a substantially hollow cone; and
situating at least a portion of the feed within the hollow cone.

40. The method of claim 39, further comprising:
providing a circuit adapted to transmit or receive a signal via the feed;
providing a battery adapted to supply electrical power to the circuit; and
situating at least a portion of the circuit and at least a portion of the battery within the hollow cone.

41. The method of claim 40, further comprising configuring the battery such that at least a portion of the battery forms a cap to substantially enclose the hollow cone.

42. The method of claim 38, further comprising:
providing a third radiating element electrically coupled to the feed; and
configuring the third radiating element to be electromagnetically coupled to and electrically insulated from the second radiating element.

43. The method of claim 38, further comprising configuring the feed to form part of or electrically coupled to a center conductor of a coaxial transmission line.

44. The method of claim 38, further comprising configuring the feed to be electrically coupled to a printed circuit board.

45. The method of claim 44, further comprising configuring the printed circuit board as a microstrip or stripline.

46. The method of claim 25, further comprising configuring the second radiating element as an electrically conductive plate.

47. The method of claim 46, further comprising configuring the electrically conductive plate to have a defined curved surface.

48. The method of claim 25, further comprising configuring the first and second radiating elements to transmit or receive a signal within a defined ultra-wide band channel that has a fractional bandwidth on the order of 20% or more, has a bandwidth on the order of 500 MHz or more, or has a fractional bandwidth on the order of 20% or more and has a bandwidth on the order of 500 MHz or more.

49. An apparatus for wireless communications, comprising:
a first means for radiating an electromagnetic signal; and
a second means for radiating the electromagnetic signal, wherein the second radiating means is electromagnetically coupled to and electrically insulated from the first radiating means, and further wherein at least one characteristic feature of the first radiating means is substantially the same as at least one characteristic feature of the second radiating means.

50. The apparatus of claim 49, wherein at least one characteristic feature of the first radiating means extends substantially perpendicular to at least one characteristic feature of the second radiating means.

51. The apparatus of claim 49, wherein at least one characteristic feature of the first radiating means extends substantially parallel to at least one second characteristic feature of the second radiating means.

52. The apparatus of claim 49, wherein at least one characteristic feature of the first radiating means extends from at least one characteristic feature of the second radiating means at a defined acute angle.

53. The apparatus of claim 49, wherein at least one characteristic feature of the first or second radiating means comprises a direction, a length, a width, a height, an area, or a volume.

54. The apparatus of claim 49, wherein the first radiating means comprises a cone and the second radiating means comprises a substantially flat plate, wherein the at least one characteristic feature of the cone comprises an area of its opening and the at least one characteristic feature of the substantially flat plate includes its surface area.

55. The apparatus of claim 49, wherein the first radiating means includes an electrically conductive plate.

56. The apparatus of claim 55, wherein the electrically conductive plate has substantially any of the following shapes: elliptical, circular, triangular, square, rectangular, diamond, or polygon.

57. The apparatus of claim 55, further comprising a metallic load electrically coupled to the electrically conductive plate.

58. The apparatus of claim 57, wherein the metallic load is substantially flat or has a shape that substantially follows at least a portion of a contour of the electrically conductive plate.

59. The apparatus of claim 49, wherein the first radiating means comprises a cone that comprises a metal or a metal and a dielectric.

60. The apparatus of claim 49, wherein the cone is substantially hollow and further comprising a cap that substantially encloses the hollow cone.

61. The apparatus of claim 60, wherein the hollow cone comprises an inner surface comprising an electrical insulator, and an outer surface comprising a metal.

62. The apparatus of claim 49, further comprising a means for feeding an electrical signal to or from the first radiating means, wherein the feeding means is electrically coupled to the first radiating means, and further wherein the feeding means is electrically insulated from the second radiating means.

63. The apparatus of claim 62, wherein the first radiating means comprises a substantially hollow cone, and further wherein at least a portion of the feeding means is situated within the hollow cone.

64. The apparatus of claim 63, further comprising:
a means for transmitting or receiving a signal via the feeding means; and
a means for supplying electrical power to the transmitting or receiving means, wherein at least a portion of the transmitting or receiving means and at least a portion of the electrical power supplying means are disposed within the hollow cone.

65. The apparatus of claim 64, wherein at least a portion of the electrical power supplying means forms a cap to substantially enclose the hollow cone.

66. The apparatus of claim 62, further comprising a third means for radiating the electromagnetic signal, wherein the third radiating means is electrically coupled to the feeding means, and further wherein the third radiating means is electromagnetically coupled to and electrically insulated from the second radiating means.

67. The apparatus of claim 62, wherein the feeding means forms part of or is electrically coupled to a center conductor of a coaxial transmission line.

68. The apparatus of claim 62, wherein the feeding means is electrically coupled to a printed circuit board.

69. The apparatus of claim 68, wherein the printed circuit board is configured as a microstrip or stripline.

70. The apparatus of claim 49, wherein the second radiating means comprises an electrically conductive plate.

71. The apparatus of claim 70, wherein the electrically conductive plate has a defined curved surface.

72. The apparatus of claim 49, wherein the first and second radiating means are adapted to transmit or receive a signal within a defined ultra-wide band channel that has a fractional bandwidth on the order of 20% or more, has a bandwidth on the order of 500 MHz or more, or has a fractional bandwidth on the order of 20% or more and has a bandwidth on the order of 500 MHz or more.

73. A headset comprising:
an antenna comprising:
a first radiating element; and
a second radiating element electromagnetically coupled to and electrically insulated from the first radiating element, wherein at least one characteristic feature of the first radiating element is substantially the same as at least one characteristic feature of the second radiating element;
a receiver adapted to receive an incoming signal including audio data from a remote apparatus via the antenna; and
a transducer adapted to generate an audio output based on the audio data.

74. A watch, comprising:
an antenna comprising:
a first radiating element; and
a second radiating element electromagnetically coupled to and electrically insulated from the first radiating element, wherein at least one characteristic feature of the first radiating element is substantially the same as at least one characteristic feature of the second radiating element;
a receiver adapted to receive data via the antenna; and
a user interface adapted to produce an indication based on the received data.

75. A sensing device for wireless communications, comprising:
an antenna comprising:
a first radiating element; and
a second radiating element electromagnetically coupled to and electrically insulated from the first radiating element, wherein at least one characteristic feature of the first radiating element is substantially the same as at least one characteristic feature of the second radiating element;
a sensor adapted to generate sensed data; and
a transmitter adapted to transmit a signal including the sensed data to a remote apparatus via the antenna.
